(19) United States
(12) Patent Application Publication
(10) Pub. No.: US 2003/0162874 A1
(43) Pub. Date: Aug. 28, 2003

(54) Organic based varnish or gelcoat, methods for its manufacture and use, and substrate comprising such varnish or gelcoat

(76) Inventors: Keith Redford, Hagen (NO); Christian Simon, Oslo (NO)

Correspondence Address: DENNISON, SCHULTZ & DOUGHERTY, 1745 JEFFERSON DAVIS HIGHWAY, ARLINGTON, VA, 22202, US

(21) Appl. No.: 10/311,339

(22) PCT Filed: Jul. 5, 2001
(86) PCT No.: PCT/NO01/00287

(51) Int. Cl. C08K 5/24; C08K 9/00

(52) U.S. Cl. 524/262; 523/216

(57) ABSTRACT

Organic based and preferably clear and glossy lacquer/varnish or an organically based gel-coat with the ability to form coatings with high wear resistance, as well as method for manufacturing same, said lacquer/varnish or gel-coat comprises a controlled amount of inorganic polymer particles mainly with a size of 1-100 nm, the particles being able to form a three-dimensional network that is independent of the organic network of the lacquer or which may have bondings to this network. The polymer particles are typically a reaction product obtained by hydrolysis and condensation reactions of monomer compounds chosen among the following groups: i) M(OR)ₙ, or ii) R′-M(OR)ₙ, where M is a metal ion, and R is an organic group chosen among alkyl, alkenyl, aryl or combinations of such groups with from 1 to 8 carbon atoms, R′═R or R—X, where X is an organic group like e.g. amine, carboxyl or isocyanate, and n is an integer between 1 and 6. Alternatively the polymer particles are natural or synthetic clay based powders or combinations of such powders. The lacquer/varnish or gel-coat is used as protective coatings on e.g. surfaces of aluminium or steel, preferably rolled aluminium or steel.

The present invention relates to an organic based lacquer/varnish or coating in the form of organic based gel coatings as defined by the preamble of claims 1 and 8. The present invention further relates to the manufacture of lacquer/varnish or coatings as defined by the preamble of claims 9, 10, 11 and 17 respectively. Still further the present invention relates to utilization of such organic based lacquer/varnish or such coating as a protective coating on surfaces of album or steel, particularly of rolled aluminium. Finally the present invention relates to a substrate comprising a coating of above mentioned type. (In the following we will generally—of practical reasons—refer to lacquers! varnishes as lacquers only).

### BACKGROUND

It is previously known to manufacture coatings in the form of lacquers that in dried form are purely organic and which have the advantage or the characteristic over lacquers with an inorganic content, that they as clear lacquers may be manufactured with significantly more glossy surfaces. It is however a disadvantage with these lacquers and coatings that their wear resistance are not particularly good, due to their inability to include conventional fillers that would change their appearance.

From SE patent application No. 9603174-5 (KompoPigment Ltd.) presents the manufacture of aqueous paintings and lacquers with a content of polymers, in which to improve the wear resistance of the painting or the lacquer, particles of SiO₂ are added, which particles have a size up to 150 nm, preferably no more than 100 nm, in a weight content of maximum 65% of the dry weight of the dispersion.

EP A1 0 555 052 describes a fluid me comprising an acryl monomer, silica particles and at least one initiator for ultraviolet curing of said mixture, as well as a component to inhibit decomposition of the mixture caused by the ultraviolet radiation. The silica particles of said mixture are typically of a size 15-30 nm. The object of said mixture is the manufacture of transparent, organic based coatings that are wear and weather resistant. The patent is limited in its scope to one organic system, namely acryl, which in its basis is a mixture of a monomer with silica particles, not an organic rest.

From a.o. EP 0 786 499 is known the fact that wear resistant coatings may be formed from a composition consisting of multifunctional organo-metallic components (designated A) that is combined with an organic monomer which includes several functional groups (designated 1). For this known method it has been shown that a strong binding is formed between the organo-metallic components and the organic monomer prior to polymerization! hardening, cfr. page 4, line 29-30. The subsequent polymerization yields a network comprising a combination of the A and B components in which the inorganic components are chemically bound to organic polymerized suture in a single common network.

From DE 199 24 644 is known a method for the manufacture of a lacquer comprising nano-particles. The method comprises in-situ formation of the particles through hydrolysis and condensation of metal oxides, so-called sol-gel synthesis. The objective with performing the manufacture in-situ as suggested, is to control the particle size so that agglomeration does not lead to larger particles than desired. This publication too concentrates on systems leading to a single, common network of matrix and nano-particles, cfr. e.g. column 2, line 63-66.

It is worth noticing that aqueous paintings and lacquers are dispersions of the relevant polymer, which after removal of the solvent (actually dispersion agent) builds a protective layer. This means that the polymer is not present in the form of an actual solution. When the water evaporates and the polymer settles on a surface, the many minor polymer particles “float together” and builds a continuous, protective coating. Even if this takes place in a degree that is good enough for many purposes, aqueous paintings and lacquers still provide a lot weaker protection than organic based lacquers and solvents, where the polymer prior to application is completely dissolved, and during the hardening builds a continuous protective layer with a basis in the single molecules of the polymer.

Due to the above mentioned chemical difference between aqueous and organic based lacquers and paintings, it is not possible just to apply a method like the one described in said Swedish patent to lacquers based on organic solvents.

It is known to add inorganic particles of a size of several micrometers (gm) to aqueous or organic based lacquer systems (so-called fillers or pigments). This modification may affect the wear resistance properties somewhat, but is rather used to change the appearance (like the colour) or to increase the weight of the lacquer. The object of the present invention is to modify the wear resistivity of clear lacquer systems without changing other properties lie brightness and glossiness.

### OBJECTIVE

It is an object with the present invention to provide a lacquer/gel-coat and coating respectively, and a method for the manufacture of such a lacquer/gel-coat, obtainable as a glossy clear lacquer or a glossy gelcoat surface with significantly improved wear resistance compared to known glossy lacquers/coatings of this type.

It is a further object to provide a coating in the form of a lacquer/gel-coat with properties that contributes to the corrosion resistance of the surfaces to be protected, hereunder avoiding that the protective layer becomes so brittle that it easily cracks and allows the entrance of humidity.

It is a further object to provide a protective layer that to a certain extent will contribute to flame retardancy.

It is a still further object to provide a lacquer and a coating respectively that is suited to provide rolled surfaces of aluminium and/or steel a protective layer that is hard, wear resistant, weather resistant, smooth, glossy and clear.

Finally it is an object to provide a method of modifying known, commercial lacquers based on organic solvents, in such a way that the above mentioned objects is obtained.

### THE INVENTION

The invention more precisely consists of a lacquer or a gel-coat of the kind mentioned initially, which is characterized by the features defined by the characterizing part of claim 1. Further and preferred embodiments of the lacquer or the gel-coat according to the invention, are defined by the claims 27. The invention further relates to a finished hardened coating as defined by claim 8.

The invention further concerns alternative embodiments of a method for the manufacture of such a lacquer or such a gel-coat as mentioned initially, which embodiments are characterized by the features defined by the characterizing parts of claims 9, 10, 11 and 17 respectively. Preferred embodiments of the method according to the invention are defined by the claims 12-16.

The invention still further concerns a utilization of such a lacquer or such a gel-coat as defined by the characterizing part of claim 18. Preferred embodiments of the utilization to according to the invention, are defined by the claims 19-21. Finally tie invention relates to substrate comprising a coating of the mentioned type.

The core of the invention may be expressed as providing the kid of lacquer or coat that the invention relates to with inorganic polymer particles of nano size, i.e. with a particle size mainly in the area 1-100 nm. Such particles cannot just be “added” in the form of particles as such, their provision need to take place through one or more of the alternative methods by which the particles are formed through chemical reactions taking place in situ or immediately prior to their addition to the base component of the lacquer. The three alternative embodiments of the method according to the invention, defined by the claims 9, 10 and 11 respectively, are in the following also designated as model 1, model 2 and model 3 respectively. It is however, also possible to combine the three methods as defined by claim 17.

An important aspect is that particles of the relevant type and size are not present as discrete particles in a lacquer matrix. The particles will rather form their own inorganic/organic network that comes in addition to the organic network of the lacquer. These two networks will be present side by side independent of each other, but they may to a larger or lesser degree be attached to each other through cross-linked bondings. The degree of network formation is to some extent dependent also by which of the three manufacturing model that is chosen and by the particle size, and cannot be predicted entirely on a theoretical basis. The invention is not, however, limited to certain degrees of network formation or to any certain mechanism for the formation of such networks. When in the following reference is made to the “particles” in the lacquer, this also is meant to include the presence of such an additional network in the finished hardened lacquer or the finished hardened coating.

Already while the lacquer/gel-coat is present in its fresh form, it will comprise varying degrees of the two networks discussed, but the degree of cross-linking in three dimensions will be significantly lower than ill the finished, hardened coating.

The practical implication of two principally independent networks is a.o. that the coating formed not only is strong, but in addition is more flexible than many other lacquers/coatings, included such where the nano-particles are tied into a network with the lacquer's organic resin. Coatings that are less flexible will soon experience crack formation if put on top of materials that themselves are flexible/movable. Rolled aluminium or steel which are wound on to big coils are typical examples of utilizations where it is vital that the finished hardened lacquer is flexible if it shall be able to provide a lasting protection to the metal.

According to a first embodiment of the method according to the invention, hereinafter designated model 1, a first particle dispersion (sol) is prepared by partial hydrolysis of one or more monomer compounds of the kind previously stated. A solvent compatible with the solvent of the lacquer to be modified is used for this purpose. Thereafter the mentioned sol is added to the lacquer, and at this stage the sol includes nano-particles of desired size. It is preferred also to modify the surface of the particles through a treatment that may comprise adsorption of polymers, reactions with a silane, a zirconate, a zircoaluminate, an orthotitanate, an aluminate or a combination of such treatments.

Chemically there are two steps in the preparation of a sol from metal-organic compounds according to some of the embodiments, model 1 and 2, of the invention A solution containing monomer compounds of the formula M(OR)ₙ or R′-M(OR)ₙ is used as a starting solution. In the formula M(OR)ₙ, M is a metal ion and R is an organic group chosen among alkyl, alkenyl, aryl or combinations of these with from 1 to 8 carbon atoms. In the formula R′-M(OR)ₙ, R′═R or R′═R—X where X is au organic group like e.g. amine, carboxyl or isocyanate. It is preferred that R is a simple alkyl with 1-4 carbon atoms. The index is an integer from 1 to 6 dependent upon the valency of the metal ion.

The first step is hydrolysis of the metal alkoxide, where alkoxide ligands are replaced by hydroxyl groups:

M-OR+H—OH→M-OH+ROH

The second step is condensation, where hydroxyl ps either may react with hydroxyl or alkoxy groups from other metal centres, forming M-O-M bonds and either water or alcohol.

M-OH+HO-M≡→≡M-O-M≡+H₂O

or

M-OR+HO-M≡Θ≡M-O-M≡+ROH

The course of reaction is principally the same if started from the compound R′-M(OR)ₙ, as the group R′ does not participate in the hydrolysis or condensation reactions.

The resulting solution consists of inorganic polymer particles dispersed in a solvent.

A preferred variant includes the addition of a compound with functional OH-groups, like e.g. butyldiglycol or ethylhexanol during the hydrolysis/condensation step. This has shown the formation of a stable sol that is compatible with lacquers/gel-coats.

E.g. when a acrylic lacquer is to be modified, it is preferred to add butyldiglycol (BDG) during the hydrolysis/condensation of γ-aminopropyltriethoxysilane (γ-APS). A BDG molecule will be able to substitute an ethoxy-group of γ-APS (-ODGB). -ODGB is probably significantly more difficult to substitute by —OH compared to the case of -OEt due to possible interactions between the, -ODGB substituent and the Si-atom. Such interactions are not significant between OEt and the Si atom. Generally it is to be expected that larger alcohol residues are more difficult to substitute by —OH due to the fact at a larger alcohol molecule subsequent to a possible hydrolysis remains for a longer period of time in the vicinity of the silane tan a smaller alcohol molecule does. As a consequence the opposite reaction (condensation between ≡Si—OH and EtOH to ≡SiOR+H₂O) is more likely for larger alcohol molecules than for smaller. It is decisive for the particle formation that only two sites on the Si-atom are available for hydrolysis/condensation. Three or four sites with possibility of hydrolysis/condensation usually leads to formation of large agglomerates which are normally difficultly soluble in organic solvents. As an alternative to the intramolecular catalysed hydrolysis/condensation, in intermolecular variant is also possible. In this case the amino group of a silane molecule in the vicinity of another silane molecule catalyses the hydrolysis/condensation of the latter silane molecule. This way nano-particles compatible with the acrylic lacquer are formed.

By a variant of the method according to the invention model 2, a controlled amount of inorganic compounds of the mentioned type is added to an existing commercial clear lacquer or an existing commercial gel-coat. To obtain in-situ formation of particles within the desired size it is necessary to establish chemical conditions ensuring a correct balance between the kinetics of the two required reactions, namely the condensation reaction and the hydrolysis. While the condensation reaction provides for the formation of polymer chains polymerizes) from monomer (single) molecules, the hydrolysis provides for a polycrystalline precipitation or oxohydroxide precipitation taking place in contact with the components of the lacquer. A suitable choice of inorganic compound combined with exchange (replacement) of alkoxide groups with strong ligands, will slow down the hydrolysis reasons compared to condensation reactions, which will ensure that said chains do not become too long, but swill stay within a range herein denoted as oligomers. In practice ibis means that the particles will often be only of a few nm in size, most typically smaller than 10 nm. It is preferred that the particles are smaller than 30 nm as that ensures that the lacquer remains bright. In the same manner as for model 1 it is preferred additionally to modify the surface of the particles though a treatment that may comprise adsorption of polymer, reaction with a silane, a zirconate, a zircoaluminate, an orthotitane, an aluminate, or a combination of such treatments.

According to a third variant of the method according to the invention, model 3, a powder of agglomerated particles of the above mentioned type is first established. The agglomerates of the powder are so loose that they may be broken down to particles of nano size with a mechanical treatment, a chemical treatment or a combination of such treatments. This implies that clay based materials represent an alternative that may be used for model 3. In the same manner as for model 1 it is preferred additionally to modify the surface of the panicles through a treatment that may comprise adsorption of polymer, reaction with a silane, a zirconate, a zircoaluminate, an orthotitane, an aluminate, or a combination of such treatments.

Common for the three mentioned embodiments/variants is that it is possible to start from existing lacquers, preferably glossy clear lacquers based on organic solvents, and to change their properties by means of a treatment with inorganic polymer particles, so that the resulting lacquer incorporates particles of nano size. These particles will as mentioned form a three-dimensional network that comes in addition to the organic network of the lacquer itself, and contributes to providing the lacquer an unsurpassed wear resistance compared to ordinary organic based lacquers, while the finished hardened lacquer still is maintains its flexibility and does not become brittle. The additional network comprising the inorganic particles is principally independent of, but may be partly bonded to, the organic network of the lacquer.

With addition of a controlled amount of inorganic polymer particles is meant an amount that is sufficient to allow the particles to form such a network as described above. The amount required will have to be determined in each separate case in dependence of particle size, particle type and type of lacquer. In general the amounts of inorganic particles will stay between an interval of from 0.5 to 50% by weight calculated on a basis of the laquer in question. At concentrations close to or below the lower of said limits the particles will only to a limited degree be able to form the network necessary to obtain the desired improvement of the lacquer's properties. At concentrations above said upper limit there is a risk that the particles will negatively affect the lacquer's appearance, so that it will no longer appear as glossy, smooth and clear as prior to the particle addition.

The metal ion M according to the invention is chosen among a series of metals, such as zirconium, aluminium, titanium, silicon, magnesium, chrome, manganese, iron, cobalt and several others. Through research it has been found that compounds where the metal ion is zirconium, aluminium, titanium, silicon or a combination of these are very well suited for the purpose, and these metals therefore constitute preferred embodiments of the metal ion according to the invention. The organic part R of the molecule is an alkyl, an alkenyl, an aryl or a combination of these groups, of practical reasons limited in size to groups comprising a maximum of 8 carbon atoms. It is however preferred that R does not have more than 4 carbon atoms, and more preferred that it is a simple allyl like methyl, ethyl, propyl or butyl. While the normal thing will be that one of the three distinct methods for modifying a base lacquer/gel-coat is chosen for a given application, it is also possible to combine two of the methods or all three methods (or elements of these methods) as defined by claim 17.

Generally coatings with a thickness between 1 and 50 μm are made, depending, on the coating method and the properties of the substrate. Due to the improved properties of the coating made according to the invention, such as high wear resistance, the coating thickness may be lower, e.g. in the range 1 to 10 μm.

Many different organic types of lacquers are suited for the purpose of the invention, and the tyke is largely decided by the area of use. To mention the most important ones, acrylic lacquers, epoxy lacquers, polyester lacquers, polyurethane lacquers, polyamide lacquers and polycarbonate lacquers, may all be used as a the basis lacquer according to the invention.

While a lacquer is applied to and adhere to a surface that is to be protected, a gel-coat is used e.g. to manufacture products like car top-boxes, plastic boats, plastic containers/tanks or body works, which may all include reinforcements in the form of glass fibres or the like. The processing steps are thus significantly different from applying a laquer even though the chemical principles of their outer layer are quite similar. When a product is gel-coated, a model with a shape complementary to the desired product is first formed in a material to which the gel-coat will not adhere with any significant strength. The gel-coat is thereafter applied to the model by means of conventional techniques, ad thereafter provided with any desired reinforcements, normally followed by another layer of gel-coat. The fist applied layer of gel-coat constitutes the outer layer of the product and has in this connection the same function as the lacquer, namely to form an attractive and strong surface, also providing UV-protection so that the material does not decompose under the top layer.

Below the invention is further elaborated through a number of test examples for some of the manufacturing methods according to the invention. It is not exemplified utilizations of steel surfaces, but it should be emphasized that they in principle is similar to the examples shown for aluminium, though the adhering properties and hardness are somewhat different for these materials.

### EXAMPLE 1

a commercial clear polyurethane lacquer (DD lacquer from Scanox, Norway) was modified according to model 2, and applied to a parquet (floor).

The polyurethane lacquer is a two component lacquer where one component is the resin (component A) and the other component is a hardener (component B).

Modification: 10 ml tetramathoxy-orthosilane (TMOS) from Sigma Aldrich, CH was added drop by drop with an interval of about 5 seconds between each drop, to 40 ml of component A under vigorous agitation (800 rpm). The entire process lasted about 40 min. 20 ml of component B was added to the solution under agitation.

Applying: After 5 minutes of agitation the lacquer was applied to two borads of parquet with a brush. The boards each had two areas, one of which received two layers of the modified lacquer while the other area received two layers of non-modified lacquer.

Testing: After 24 hours the lacquer was completely hardened. The thickness was measured to about 20 μm and the wear resistance was tested by means of a Universal Wear Testing Machine from Eyre/Biceri. One of the lacquered boards was strapped to the machine that comprised a steel knife. The movable part was placed on the board with a constant weight and the apparatus was started. The number of turns were automatically counted. After 80 turns the surface was observed. On the part covered with non-modified lacquer almost all the lacquer was worn off. On the part covered with modified lacquer, the lacquer was worn very moderately.

The other board was exposed to a burning flame for at least 20 seconds and thereafter observed. The part covered with modified lacquer had turned white due to formation of a thin oxide layer that served to inhibit the flames. The part covered with the non-modified lacquer was completely black and had started burning immediately after contact with the flames.

### EXAMPLE 2

A commercial clear epoxy lacquer VS 150 from Valspar, USA was modified according to model 2 and used for coating of aluminium sheets. The eopxy lacquer was a one component lacquer comprising both the resin and a cross-linker.

Modification: 20 ml of a mixture of 61 g tetaaethoxy-orthosilane (TEOS) from Sigma Aldrich, CH, 200 g butanol and 121 g aluminium sec-butoxide from Sigma Aldrich, CH was added dropwise with about 2 second intervals between each drop to 40 ml of lacquer under vigorous agitation (800 rpm) The entire process lasted about 40 minutes.

Applying: After 5 minutes of agitation the lacquer was applied to an aluminium sheet by “bar coating” (rod number 26). Immediately after application the sheet was placed in a convection oven holding the temperature of the aluminium sheet (“Peak Metal Temperature” PMT) at 250° C. The sheet was thereafter removed from the oven and cooled in cold water. The coated layer was measured to 8 μm.

Testing: The wear resistance properties were tested by means of a hardness pen of type Erichsen, Germany. The method consists of mating a scratch with the hardness pen. The force applied being controlled by a spring. The hardness value correlated to the force is read from the pen. Parallel readings showed that the force on the sheet covered by the modified lacquer was beyond 1 N, while the force on the sheet covered by the non-modified lacquer was below 0.2 N.

### EXAMPLE 3

A commercial clear acrylic lacquer (SZ-006 from Rhenania, Germany) was modified according to model 2 and used for coating ammonium sheets.

The acrylic lacquer was a one-component lacquer containing both resin and cross-linkers.

Modification: 4.7 g of tetra isopropyl orthotitane from Sigma Aldrich, CH was added to 12.9 g methacrylic acid under agitation. After 15 minutes of agitation the solution was added to 26.4 g lacquer under agitation.

Application: After 5 minutes of agitation the lacquer was applied to an aluminium sheet using “bar coating” (rod No. 26). Immediately thereafter the sheet was placed in a convection oven, holding the temperature of the aluminium sheet (“Peak Metal Temperature” PMT) at 241° C. The sheet was thereafter removed from the oven and cooled in cold water. The coated layer was measured to 8 μm.

Testing:

Wear Resistance.

The wear resistance properties were tested by means of a Universal Wear Testing Machine from Eyre/Biceri. One of the lacquered sheets was strapped to the apparatus. A cotton pole was attached to the movable part and placed on the lacquered sheet with a constant weight of 588 g (3×load) and the apparatus was started. The number of turns was automatically counted. After 20 turns the surface of the sheet was metallized and observed. The number of die lines on the part coated with non-modified lacquer was comparatively large. On the part coated with modified lacquer the die lines were barely visible. On an empiric scale from 1 to 6 where 1 is best (no die lines) and 6 worst (many die lines) the modified lacquer got value 2 and the non-modified lacquer got value 3.

Clearness

The lacquer was optically clear. The clearness of a lacquer may be quantified by measuring the brightness (RD/20). The brightness of the modified lacquer had a value of 1793, which was in the magnitude of the brightness of the non-modified lacquer (1773).

### EXAMPLE 4

The same commercial lacquer as used for example 3 was modified according to model 1 and used for coating aluminium sheets.

Modification: 11.34 g of an alcoholate solution of titanium propoxide from Sigma Aldrich, CH was added to 7.74 hexanoic acid under agitation. Thereafter 1 g of distilled water was added under agitation. After 15 minutes of agitation, 10 g of the resulting sol was added to 0.165 g γ-aminopropyl triethoxysilane under agitation. 1 g of the resulting mixture was thereafter added to 10 g lacquer under agitation.

Application: After 5 minutes of agitation the lacquer was applied to an aluminum sheet by “bar coating” (rod NO. 26). Immediately thereafter the sheet was placed in a convection oven, holding the temperature of the aluminium sheet (“Peak Metal Temperature” PMT) at 241° C. The sheet was thereafter removed from the oven and cooled in cold water. The coated layer was measured to 8 μm.

Characterizing and Testing

Sol Particle Size

The sol particle size was determined by means of the light scattering principle. A commercial instrument, “Zetasizer 37” from Malvern, UK, was used to determine the size distribution. The size distribution was sharp and the average particle size was 5 nm.

Wear Resistance Properties

The wear resistance properties were tested by means of a Universal Wear Testing Machine from Eyre/Biceri, as for example 3. The constant weight was 588 g (3×load). The number of die lines on the part coated with non-modified lacquer was comparatively large. On the part coated with modified lacquer the die lines were barely visible. On an empiric scale from 1 to 6 where 1 is best (no die lines) and 6 worst (many die lines) the modified lacquer got value 2 and the non-modified lacquer got value 3.

Clearness.

The lacquer was optically clear. The clearness of a lacquer may be quantified by measuring diffuse transmission. This may be performed e.g. by using a clear glass plate as a substrate for the lacquer. First the diffuse transmission is measured on the glass plate alone. Thereafter the lacquer is applied to the glass plate and the diffuse transmission is measured again. The change in diffuse transmission after the application of the lacquer is a good measure of the clearness of the lacquer (provided that the interface between lacquer and the glass plate does not contribute significantly to the light scattering). The measurements was done with an apparatus according to the DIN 5036 standard.

Diffuse transmission of the clear glass plate was measured to 0.5%. The non-modified lacquer was applied to the glass plate (coating layer of 5 μm). The diffuse transmission was thereafter measured to 1.5%. Diffuse transmission for the modified lacquer was measured below 6%.

### EXAMPLE 5

The commercial lacquer used for example 3 was modified according to model 1 and applied to aluminium sheets.

Modification: 4.7 g of tetra isopropyl orthotitane from Sigma Aldrich, CH was added to 15.3 g pentanoic (valeric) acid under agitation. Thereafter 0.45 g of distilled water was added under agitation. After 15 minutes agitation of this sol 10 g sol was added to 10 g lacquer under agitation.

Application: After 5 minutes of agitation the lacquer was applied to an aluminium sheet by “bar coating” (rod NO. 26). Immediately thereafter the sheet was placed in a convection oven, holding the temperature of the aluminium sheet (“Peak Metal Temperature” PMT) at 241° C. The sheet was thereafter removed from the oven and cooled in cold water. The coated layer was measured to 8 μm.

Characterizing and Testing

Sol Particle Size

The sol particle size was measured by means of “Zetasizer 3” from Malvern, UK. The size is distribution was sharp and the average particle size was 3 nm.

Wear Resistance Properties.

The wear resistance properties were tested by means of a Universal Wear Testing Machine from Eyre/Biceri, as for example 3. The constant weight was 980 g (5×load). The number of die lines on the part coated with non-modified lacquer was comparatively large. On the part coated with modified lacquer the die lines were barely visible. On an empiric scale from 1 to 6 where 1 is best (no die lines) and 6 worst (many die lines) the modified lacquer got value 3 and the non-modified lacquer got value 6.

Clearness

The lacquer was optically clear. The clearness of a lacquer may be quantified by measuring the brightness (RD/20). The brightness of the modified lacquer had a value of 1693, which was comparable to the brightness of the non-modified lacquer (1773).

### EXAMPLE 6

The same commercial lacquer as used for example 3 was modified according to model 3 and applied to aluminium sheets.

Modification: 10 g of a commercial titanium oxide from Nanophase, USA, comprising titania particles with an average size of 20 nm (20% by weight in an organic solvent) was added to 10 g lacquer under agitation.

Application: After 5 minutes of agitation the lacquer was applied to an album sheet by “bar coating” (rod NO. 26). Immediately thereafter the sheet was placed in a convection oven, holding the temperature of the aluminium sheet (“Peak Metal Temperature” PMT) at 241° C. The sheet was thereafter removed from the oven and cooled in cold water. The coated layer was measured to 8 μm.

Testing: The wear resistance properties were tested using a “taber abraser” like for example 3. The weight loss measured for the sheet coated with the non-modified lacquer was significantly larger than the weight loss of the sheet coated with the modified lacquer.

### EXAMPLE 7

A commercial clear gel-coat was modified according to model 1 and used for providing a protective layer on a glass reinforced polyester plate.

Modification: A zirconia sol adapted to styrene was manufactured by mixing 40 ml of a Zr(OPr)₄ solution from Sigma Aldrich, CH with 29.6 ml methacrylic acid under agitation. When the composition bad reached room temperature 3.72 ml water was slowly added under agitation. Thereafter 40 ml of styrene was added. Unsaturated polyester was added to the composition to yield a 70% polyester. After the addition of peroxide the composition was applied to a mould with a brush and reinforced with polyester/glass.

Testing: The wear resistance properties were tested with a hardness pen from Erichsen, Germany. No scratches (die lines) was observed. When the same force (N)was applied to a non-modified gel-coat, a lot of die-lines were observed.

### EXAMPLE 8

A commercial clear epoxy lacquer was modified according to model 3 and applied to aluminium sheets.

The epoxy lacquer was a one-component lacquer comprising both the resin and the cross linker.

Modification: 9 g of a commercial bohemite powder from Condea Chemi was added to 20 g butanol under agitation. Thereafter 2.14 g of methacrylic acid was added under agitation. After 15 minutes of agitation the resulting sol was subjected to an ultrasound treatment (300 W 5 min., 50% pulse), and the sol was added to 10 g of lacquer under agitation.

Application: After 5 mutes of agitation the lacquer was applied to an aluminium sheet by “bar coating”. Immediately thereafter the sheet was placed in a convection oven, holding the PMT at 250° C. The sheet was thereafter removed from the oven and cooled in cold water.

Testing: The wear resistance properties were tested using a “taber abraser” like in example 3, the sheet being weighed before and after the test. The weight loss measured for the sheet coated with the non-modified lacquer was significantly larger than the weight loss of the sheet coated with the modified lacquer.

### EXAMPLE 9

The same commercial lacquer as used for example 3 was modified according to model 3 and applied to aluminium sheets.

Modification: 3 g of a commercial titanium oxide powder from Tioxide, England was added to 6 g of butyldiglycol (BDG) and 8.33 g of 1-methoxy-1-acetoxypropane. The resulting dispersion was thereafter subjected to an ultrasound treatment for 17 minutes (200 W, 50% cycle). Thereafter the components of the lacquer was added in the following sequence and under agitation: 0.0072 g of PTSA solution, 7.2 g of Melamine resin solution, 9 g of blocked HDI isocyanate resin-solution and 29.4 g of acrylic resin solution.

Application: After 5 minutes of agitation the lacquer was applied to an aluminium sheet by “bar coating” (tad NO. 26). Immediately thereafter the sheet was placed in a convection oven, holding the temperature of the aluminium sheet (“Peak Metal Temperature” PMT) at 241° C. The sheet was thereafter removed from the oven and cooled in cold water. The coated layer was measured to 12 μm.

Testing

Wear Resistance Properties.

The wear resistance properties were tested by means of a Universal Wear Test Machine from Eyre/Biceri, as in example 3. The constant weight was 588 g (3×load). The number of die lines on the part coated with non-modified lacquer was comparatively large. On the part coated with modified lacquer the die lines were barely visible. On an empiric scale from 1, to 6 where 1 is best (no die lines) and 6 worst (many die lines) the modified lacquer got value 1 and the non-modified lacquer got value 3.

Clearness

The lacquer was optically clear. The clearness of a lacquer may be quantified by measuring the brightness (RD/20). The brightness of the modified lacquer had a value of 1727, which was comparable to the brightness of the non-modified lacquer (1693)

### EXAMPLE 10

The same commercial lacquer as used for example 3 was modified according to model 1 and applied to aluminium sheets.

Modification: 60 g of γ-aminopropyltriethoxysilane (γ-APS) was added to 13.2 g of BDG and 15.18 g of distilled water. The sol was agitated moderately for 12 hours. 5 g of the sol was then added to 1 g of lacquer under moderate agitation.

Application: After 5 minutes of agitation the lacquer was applied to an aluminium sheet by “bar coating” (rod NO. 26). Immediately thereafter the sheet was placed in a convection oven, holding the temperature of the aluminium sheet (“Peak Metal Temperature” PMT) at 241° C. The sheet was thereafter removed from the oven and cooled in cold water. The coated layer was measured to a thickness of 7 μm.

Testing

Wear Resistance Properties

The wear resistance properties were measured by means of a “taber abraser” according to ISO standard D 4060-95. The method comprises exposing the lacquered surge to wear by means of a rubber wheel rotating on the sample. The number of turns is automatically registered (1000 turns), and the force is determined by a known weight (500 g). The sheets are weighed before and after the test. The weight loss of the sheet coated with non-modified lacquer was 2.37 mg, wile the weight loss of the sheet coated with the modified lacquer was 1.22 mg.

The wear resistance properties were also tested by means of a Universal Wear Testing

Machine from Eyre/Biceri, as in example 3. The constant weight was 980 g (5×load). The number of die lines on the part coated with non-modified lacquer was comparatively large. On the part coated with modified lacquer the die lines were barely visible. On an empiric scale from 1 to 6 where 1 is best (no die lines) and 6 worst (many die lines) the modified lacquer got value 1 and the non-modified lacquer got value 6.

### EXAMPLE 11

The same commercial lacquer as used for example 3 was modified according to model 1 and applied to aluminium sheets.

Modification: 100 g of a commercial silica sol from Nissan Chemicals, Japan, was added to 22.4 g γ-APS under slow agitation for 5 minutes. 10.2 g of the modified sol was thereafter added to a mixture of 3.3 g of γ-APS and 1.5 g of BDG under slow agitation 5.1 g of the resulting composition was added to 1 g of lacquer under slow agitation.

Application: After 5 minutes of agitation the lacquer was applied to an aluminium sheet by “bar coating” (rod No. 26). Immediately thereafter the sheet was placed in a convection oven, holding the temperature of the aluminium sheet (“Peak Metal Temperature” PMT) at 241° C. The sheet was thereafter removed from the oven and cooled in cold water. The coated layer was measured to a thickness of 7 μm.

Testing

Wear Resistance Properties.

The wear resistance properties were tested by means of a Universal Wear Testing Machine from Eyre/Biceri, as in example 3. The constant weight was 588 g (3×load). The number of die lies on the part coated with non-modified lacquer was comparatively large. On the part coated with modified lacquer the die fines were barely visible. On an empiric scale from 1 to 6 where 1 is best (no die lines) and 6 worst (many die lines) the modified lacquer got value 1 and the non-modified lacquer got value 3.

The tables below summarizes the types of lacquers/varnishes used and the results of the various hardness tests and brightness tests.

TABLE 1
Characterization of various types of lacquers prior to and
after their modification according to model No 1.

| | | | | Sratch test | Taber abraser | |
|---|---|---|---|---|---|---|
| Ex. | Type of | Model | Type of | (1 = best, 6 = worst) | Weight loss | Bright- |
| No. | lacquer | No. | modification | 3× load (see text) | (mg) | ness |
| 4 | Acrylic | | Non-modified | 3 | | |
| 4 | Acrylic | 1 | Ti | 2 | | |
| 5 | Acrylic | | Non-modified | 6* | | 1773 |
| 5 | Acrylic | 1 | Ti | 3* | | 1693 |
| 7 | Epoxy | | Non-modified | −** | | |
| 7 | Epoxy | 1 | Ti | +** | | |
| 10 | Acrylic | | Non-modified | 6* | 12.37 | |
| 10 | Acrylic | 1 | Si | 1* | 1.22 | |
| 11 | Acrylic | | Non-modified | 3 | | |
| 11 | Acrylic | 1 | Si | 1 | | |

5X load (see text)
**see text

TABLE 2
Characterization of various types of lacquer prior to and after their modification
according to model No. 2.

| Ex. | Type of | | Type of | Scratch test | Hardness pen | Bright- |
|---|---|---|---|---|---|---|
| No. | lacquer | Model No. | modification | (1 = best, 6 = worst) | (N) | ness |
| 1 | PU | | Non-modified | −** | | |
| 1 | PU | 2 | Si | +** | | |
| 2 | Epoxy | | Non-modified | | 0.2 | |
| 2 | Epoxy | 2 | Si/Al | | >1 | |
| 3 | Acrylic | | Non-modified | 3 | | 1793 |
| 3 | Acrylic | 2 | Ti | 2 | | 1773 |

**see text

TABLE 3
Characterization of various types of lacquers prior to and after their modification
according to model No. 3.

| Ex. | Type of | | Type of | Scratch test | Taber abraser | Bright- |
|---|---|---|---|---|---|---|
| No. | lacquer | Model No. | modification | (1 = best, 6 = worst) | Weight loss | ness |
| 6 | Gel-coat | | Non-modified | | −** | |
| 6 | Gel-coat | 3 | Zr | | +** | |
| 8 | Acrylic | | Non-modified | | −** | |
| 8 | Acrylic | 3 | Al | | +** | |
| 9 | Acrylic | | Non-modified | 3 | | 1693 |
| 9 | Acrylic | 3 | Ti | 1 | | 1727 |

**see text

The results from the various tests show that lacquer systems with a high wear resistance are achieved through the modification according to (any one of) three embodiments of the method according to the invention, while the brightness of the lacquer is maintained.

It is emphasized that the present invention largely is related to modification of existing, commercial lacquers/varnishes or gel-coats, but is not exclusively limited to such products. The invention is thus applicable to other lacquer/varnishes, e.g. special lacquers that have not earlier been commercially available and new lacquers or varnishes that may possible constitute separate invention per se., etc.

Furthermore, we have for simplicity described modifications of lacquers/varnishes or gel-coats that are ready for use. In a commercial situation it may very well be more convenient to perform the modification by introducing the nano-particles as another step of the process than the very last one.

Still further, we have described the process in a manner in which the lacquer/vanish each time receives an amount of particles corresponding to a relevant field of use. It is also possible to add higher concentrations of particles, in which case the user immediately prior to application will dilute the concentrate with a standard lacquer/varnish of the same type to the desired concentration, which in addition may vary according to wear intensity, the substrate to which it is applied etc.

Finally, in connection with the method of manufacturing a lacquer according to the invention, the three alternative methods are described in a way that they may be perceived as being mutually exclusive in any practical situation, so that if model 1 is chosen, model 2 and 3 are automatically discarded for that particular application. This is however, not correct, as it is fully possible to combine the three models. For example a system may be applied in which a finely dispersed powder (model No. 3) is added, while simultaneously producing other inorganic particles from a particle dispersion according to model No. 1 or by in-situ formation to in the lacquer according to model No. 2 of the invention.

Said variations are all within the scope of the invention, as are any other modification that a skilled professional might introduce in order to, adapt the spirit of the invention to relevant areas of use.

1. Method for the manufacture of a lacquer/varnish or gel-coat, preferably a glossy, clear lacquer/varnish or gel-coat, by modifying a base lacquer/varnish or gel-coat chosen among existing, commercial organic based curable lacquers/varnishes or gel-coats,
characterized by the following steps:
(first) preparing a sol (particle dispersion) by partial hydrolysis of a solution containing one or more inorganic monomer compounds chosen among the following groups:
i) M(OR)ₙ, or ii) R′-M(OR)ₙ, where M is a metal ion and R an organic group chosen among alkyl, alkenyl, aryl or combinations of such groups with from 1 to 8 carbon atoms, R′═R or R—X, where X is an organic group like e.g. amine, carboxyl or isocyanate, and n is an integer between 1 and 6,
whereafter said sol is mixed with the base lacquer-varnish or gel-coat in such a way and in dependence of the base lacquer/varnish or gel-coat in question that the inorganic polymer particles become dispersed as particles with a particle size in the area 1-100 nm, while said particles through a process of condensation are able to form a three dimensional network principally independent of the network of the lacquer/varnish or gel-coat.

2. Method as claimed in claim 1,
characterized in that the solvent of the sol is at least partially removed prior to the mixing of the soil particles and the base lacquer/varnish or gel-coat.

3. Method as claimed in claim 1 or 2,
characterized in that a compound including functional OH groups with a molecular weight higher than 70, e.g. butyldiglycol or ethylhexanol, is added or prepared in-situ through a process of hydrolysis and condensation.

4. Method as claimed in one of the preceding claims,
characterized in that the particles are subjected to a surface modification through a treatment comprising adsorption of polymers, reaction with a silane, a zirconate, a zircoaluminate, an orthothianate, an aluminate or a combination of such treatments.

5. Method as claimed in one of the preceding claims,
characterized in that the metal ion M is chosen from the group consisting of zirconium, aluminium, titanium, silicon or combinations of these.

6. Method as claimed in one of the preceding claims,
characterized in that R is a group with up to 4 carbon atoms, particularly methyl, ethyl, propyl, butyl or a combination of these groups.

7. Method as claimed in one of the preceding claims,
characterized in that the reaction conditions are adapted to ensure that said inorganic polymer particles are manufactured, with a particle size less than 30 nm.

8. Organic based and preferable clear and bright lacquer/varnish or an organically based gel-coat,
characterized in that it is obtainable by the method according to any of claims 1-7.

9. Organic based lacquer/varnish or gel-coat as claimed by claim 8,
characterized in that said inorganic polymer particles are present in a non-cured lacquer/varnish in an amount of 0.5-50% by weight.

10. Coating with flexibility and high wear resistance based on a clear and glossy lacquer/varnish or gel-coat as claimed in claims 8 or 9,
characterized in that said inorganic polymer particles have formed a three dimensional network that is principally independent of the network formed by the organic phase.

11. Utilization of organic based and preferably clear and glossy lacquer/varnish or gel-coat as claimed by claim 8 as protective surface coating on surfaces of aluminium or steel, preferably rolled aluminium or steel.

12. Substrate,
characterized in that it comprises a coating with flexibility and high wear resistance as defined by claim 10.
